(19) United States
(12) Patent Application Publication
(10) Pub. No.: US 2003/0117500 A1
(43) Pub. Date: Jun. 26, 2003

(54) Network video recording system

(75) Inventor: Chih-Chung Lin, Taipei (TW)

Correspondence Address: Richard P. Berg, Esq., c/o LADAS & PARRY, Suite 2100, 5670 Wilshire Boulevard, Los Angeles, CA, 90036-5679, US

(73) Assignee: ICP Electronics Inc.

(21) Appl. No.: 10/139,923

(22) Filed: May 6, 2002

(30) Foreign Application Priority Data
Dec. 24, 2001 (TW) 90132080

(51) Int. Cl. H04N 5/232; H04N 7/18

(52) U.S. Cl. 348/211.3; 348/211.5; 348/211.8; 348/143

(57) ABSTRACT

A network video recording system. The system includes at least one video server, at least one network storage device, and a monitoring device. The video server controls a video camera in order to obtain video image data by video recording, and sends the data via a network. The network storage device is connected to the video server with the network to receive the video image data sent by the same via the network and stores the video image data. The monitoring device is connected to the video server and the network storage device with the network for monitoring the video image data sent by the video server. The monitoring device of the present invention may be used as a monitoring interface, or control the network storage device to send the video image data stored therein to the monitoring device for required inspection.

### BACKGROUND OF THE INVENTION

1. Field of the Invention

The present invention relates to a video recording system to perform video monitoring and video recording via network, and particularly to a network video recording system to perform video monitoring and video recording with a network attached storage via network.

2. Description of the Related Art

Camera server systems are widely used in security surveillance. For example, it is possible for a doorman or guard to watch guarded areas from a monitor screen with periodical patrols by providing a video camera to monitor the area and transmit the video recorded via a network.

The conventional camera server system can be described with reference to FIG. 1. A supervisory computer 110 serves as a master terminal of the camera server system, and a plurality of camera servers 120 is connected to the supervisory computer 110 via the network. Each of the camera servers 120 is connected to several video cameras 130, so that each video camera 130 records the video image and sends it to the corresponding camera server 120, in which the video image is transformed to digital video image. Thus, a user (e.g. the doorkeeper or the guard) may access and monitor the digital video image transformed by the camera servers 120 from the supervisory computer 110 via the network.

However, there are significant drawbacks in the conventional camera server system. Conventionally, the camera server 120 used in the conventional camera server system is basically a server transforming the video image recorded by the video cameras 130 to digital video image, so that the supervisory computer 110 may conveniently receive the transformed digital video image via network. It is convenient to remotely monitor the digital video image transformed by the camera server 120; however, the camera server 120 does not perform desired video image recording function, such as long-time continuous video image recording, because the camera server 120 is diskless. As a result, it is obvious that the camera server 120 of the conventional camera server system is not desirable in performing video image recording function.

Accordingly, two methods enhance the video image recording function of the conventional camera server system. One presets the desired network video recording conditions, e.g. a condition in which an object shown on a certain range of the screen moves in a certain period. In this case, once the video camera 130 receives a signal that corresponds to the preset conditions, the video camera 130 records and sends the video image to the camera server 120, and the camera server 120 sends the corresponding digital video image by any available file transfer method, such as File Transfer Protocol (FTP), e-mail, etc., to the supervisory computer 110 via the network. However, there is limitation of file size in FTP or e-mail transmission, which leads to interrupt of the digital video image transmission by FTP or e-mail. This limitation increases difficulty of desired uninterrupted network video recording with the conventional camera server system.

The other method is to execute an application program on the supervisory computer 110 to control the camera server 120, so that the camera server 120 sends the digital video image to the supervisory computer 110 and stores the digital video image in the supervisory computer 110. In this case, however, the supervisory computer 110 performs both monitoring and digital video image storing, which leads to heavy loading of data processing on the supervisory computer 110. Further, the supervisory computer 110 requires a storage device, such as a hard disk, with large amounts of free space for storing the digital video images received from the camera server 120, and expandable storage or backup device for backup video data, so that device costs increase. Further, the supervisory computer 110 controls the digital video image storing process, so that if any problem occurs in the supervisory computer 110, the camera server system loses monitoring function while being unable to store the incoming digital video image. This reduces the reliability of the conventional camera server system.

### SUMMARY OF THE INVENTION

In view of this, the present invention discloses a network video recording system, in which a video server is applied instead of the conventional camera server, so that the video server controls the network video image data storing process. In this case, the video image data recorded is sent to a network storage device for uninterrupted storing, thus solves the problem occurred in the conventional camera server system.

The present invention discloses a network video recording system, which comprises at least one video server, at least one network storage device and a monitoring device. The video server controls a video camera in order to obtain video image data by video recording, and sends the video image data via a network. The network storage device is connected to the video server with the network for receiving the video image data sent by the video server via the network and storing the video image data. The monitoring device is connected to the video server and the network storage device with the network for monitoring the video image data sent by the video server.

The monitoring device of the present invention may be used as merely a monitoring interface, or may control the network storage device to send the video image data stored in the network storage device to the monitoring device for required inspection. Further, the network storage device can be a network attached storage (NAS) or a file server, and may preferably generate and store backup image data corresponding to the video image data.

Further, the network video recording system of the present invention may be applied in any type of network, such as a local area network (LAN), a wide area network (WAN), a wireless LAN or a broadcast system.

### BRIEF DESCRIPTION OF THE DRAWINGS

The present invention can be more fully understood by reading the subsequent detailed description in conjunction with the examples and references made to the accompanying drawings, wherein:

FIG. 1 is a schematic diagram showing the conventional network video recording system; and

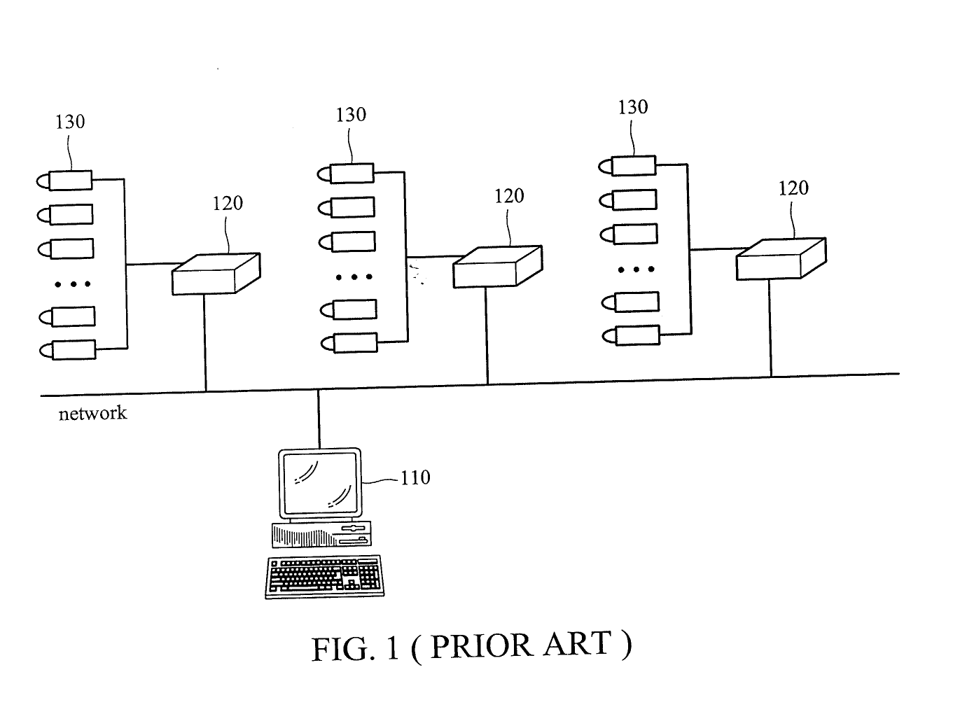

FIG. 2 is a schematic diagram showing an embodiment of the network video recording system of the present invention.

### DETAILED DESCRIPTION OF THE PREFERRED EMBODIMENT

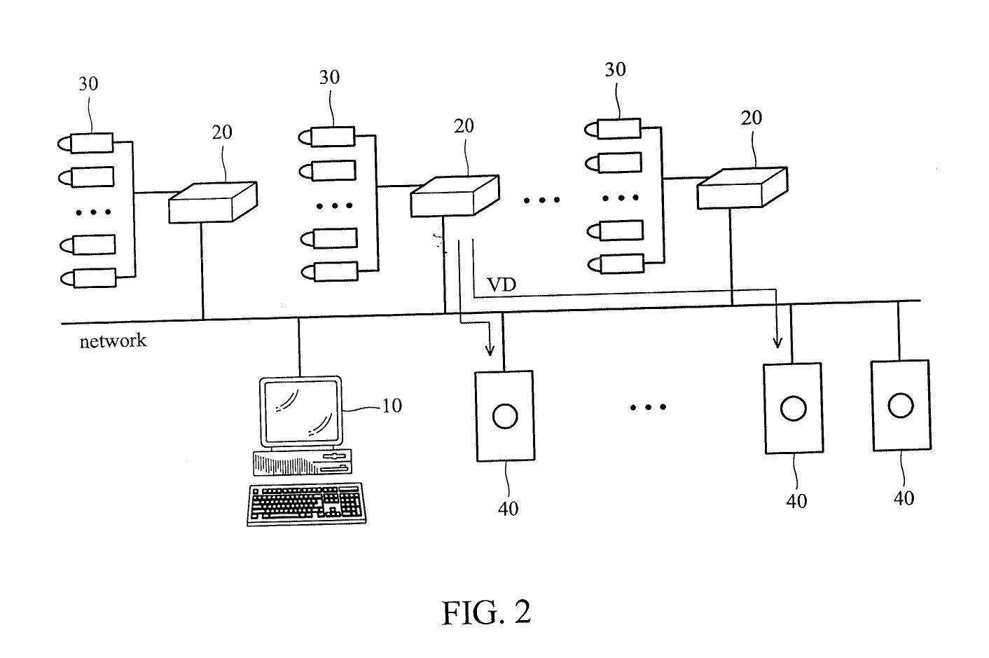

An embodiment of the network video recording system of the present invention is described hereinafter in detail with reference to FIG. 2. It should be noted that a video server 20 is applied in the network video recording system of the present invention instead of the conventional camera server, and a network storage device 40 is further applied in the present invention.

The network video recording system of the present invention has a monitoring device 10, such as a computer as shown in FIG. 2 or a terminal device, to perform monitoring of the system. The monitoring device 10 is connected to each of the video server 20 with a network, such as a local area network (LAN), a wide area network (WAN), a wireless LAN or a broadcast system. Each of the video server 20 controls at least one video camera 30 in order to obtain video image data VD by uninterrupted video recording, and sending the video image data VD to the network storage device 40 via the network. The network storage device 40 may be a network attached storage (NAS), which receives the video image data VD sent by the video server 20 via the network, and stores the video image data VD. Additionally, the network storage device 40 can be a file server. The monitoring device 10 is merely a monitoring interface in general; however, the monitoring device 10 may control the network storage device 40 to send the video image data stored in the network storage device 40 to the monitoring device 10 for required inspection.

In the present invention, the video server 20 sends the uninterrupted video image data VD to the network storage device 40 via the network, so that the monitoring device 10 does not require any application program for controlling the network video image data storing process, and the video image data transmission is not limited to the file size limitation of FTP or e-mail transmission.

Further, the network storage device 40 is applied to store the video image data VD, so that it is easier for the network storage device 40, such as the NAS, to generate and store backup image data, such as a mirror data, corresponding to the video image data. Thus, the reliability of the video image data stored in the network storage device 40 is significantly increased.

Further, the network storage device 40 is an independent device connected to the network instead of the conventional peripheral storage attached to the monitoring device 10 or the video server 20. As a result, it will be convenient to apply more than one network storage device 40 to expand the storage capacity when required, so that the video server 20 stores the video image data in an additional network storage device 40 once the primary network storage device 40 is full of video image data or has any problem in operation. Thus, the present invention enables long-time uninterrupted network video image recording, and further enhance the reliability of the network video recording system.

Further, the monitoring device 10 is mainly a monitoring interface, and the network storage device 40 is independent from the monitoring device 10, so that the network storage device 40 can be operated regularly even if any problem occurs in the monitoring device 10. Further, the video server 20 controls the network video image data storing process, so that the heavy loading occurred in the conventional monitoring device is distributed in the present invention. Moreover, the present invention enables more than one monitoring device 10 applied in the network video recording system, so that reliability in network video image monitoring is further ensured.

The network storage device 40, such as the above-mentioned NAS, may provide required security functions, such as protection of access control or disk array distribution access. In this case, the video image data stored in the network storage device 40 is further prevented from inappropriate access or modification by any unauthorized user. Thus, the present invention enables secure and stable network access at a relatively fast access speed.

While the present invention has been described with reference to the preferred embodiments thereof, it is to be understood that the invention is not limited to the described embodiments or constructions. On the contrary, the invention is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A network video recording system, comprising:
a video server controlling a video camera in order to obtain video image data by video recording, and sending the video image data via a network;
a network storage device, connected to the video server with the network for receiving the video image data sent by the video server via the network and then storing the video image data; and
a monitoring device connected to the video server and the network storage device with the network for monitoring the video image data sent by the video server.

2. The network video recording system according to claim 1, wherein the monitoring device controls the network storage device to send the video image data stored therein to the monitoring device.

3. The network video recording system according to claim 1, wherein the network storage device is a network attached storage (NAS).

4. The network video recording system according to claim 1, wherein the network storage device is a file server.

5. The network video recording system according to claim 1, wherein the network storage device generates backup image data corresponding to the video image data and stores the same herein.

6. The network video recording system according to claim 1, wherein the network is a local area network (LAN).

7. The network video recording system according to claim 1, wherein the network is a wide area network (WAN).

8. The network video recording system according to claim 1, wherein the network is a wireless LAN.

9. The network video recording system according to claim 1, wherein the network is a broadcast system.
